(19) United States
(12) Patent Application Publication
(10) Pub. No.: US 2008/0014338 A1
(43) Pub. Date: Jan. 17, 2008

(54) Dual reservoir handliner apparatus, system and method

(76) Inventor: Thomas Waxler, Douglasville, GA (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/714,712

(22) Filed: Mar. 5, 2007

Related U.S. Application Data
(60) Provisional application No. 60/779,011, filed on Mar. 3, 2006.

(51) Int. Cl. B67D 5/60; B67D 5/62; B05B 7/06; B05C 19/00; B05D 5/06

(52) U.S. Cl. 427/137; 222/132; 118/313; 118/308; 427/180

(57) ABSTRACT

A dual reservoir handliner apparatus, system and method. In a typical embodiment, the apparatus includes a carrier cart, a thermoplastic reservoir located in a forward position on the carrier cart; and a dual reservoir located in a position rearward of the thermoplastic reservoir.

### RELATED APPLICATIONS

The present Nonprovisional Application is related to, and hereby claims priority to and the benefit of, U.S. Provisional Application No. 60/779,011, entitled “Dual Reservoir Handliner Apparatus, System and Method,” filed on Mar. 3, 2006.

### BACKGROUND

I. Field of the Invention

The present invention relates generally to the field of striping for roads and other surfaces, and more particularly to a dual reservoir handliner apparatus, system and method.

II. Description of the Related Art

Striping for roads, pavement and other surfaces is well-known. Over the past several decades, thermoplastic has been used to form stripes on the above-mentioned surfaces. Furthermore, handliners have been developed in which an individual user manually pushes a cart that distributes thermoplastic on the surface. In a typical use, thermoplastic is applied to a surface and, immediately following application of the thermoplastic, glass beads are embedded in the molten thermoplastic, which subsequently cools and the glass beads remain embedded. The glass beads are typically added in order to provide reflectivity from the stripes, which is particularly useful in reflecting the light from automobile headlights. Often times, regulations require that certain reflectivity levels be attained. As such, requirements for different bead sizes are imposed upon the users who install the striping on the surfaces.

### SUMMARY

In general, the invention features a dual reservoir handliner apparatus, system and method.

In general, in one aspect, the invention features a handliner apparatus, including a carrier cart, a thermoplastic reservoir located in a forward position on the carrier cart; and a dual reservoir located in a position rearward of the thermoplastic reservoir.

In one implementation, the dual reservoir includes beads stored within the reservoir.

In another implementation, the dual reservoir comprises a first chamber and a second chamber.

In another implementation, the first chamber is disposed between the thermoplastic reservoir and the second chamber.

In another implementation, the apparatus further includes a first hopper connected to the first chamber via a first conduit.

In another implementation, the apparatus further includes a second hopper connected to the first chamber via a second conduit.

In another implementation, the dual reservoir supplies a first stream of glass beads and a second stream of glass beads.

In another implementation, the first stream of beads is distributed via a first roller and metering shaft assembly connected to the carrier cart.

In another implementation, the second stream of beads is distributed via a second roller and metering shaft assembly connected to the carrier cart.

In another aspect, the invention features a method of striping, including applying a layer of heated thermoplastic to a surface, upon applying the heated layer of thermoplastic, applying a first layer of glass beads to the layer of thermoplastic and upon applying the first layer of glass beads to the layer of thermoplastic, applying a second layer of glass beads to the combined layers of thermoplastic and first layer of glass beads.

In one implementation, the thermoplastic is extruded from a thermoplastic reservoir.

In another implementation, the first layer of beads is supplied from a first bead reservoir.

In another implementation, the second layer of beads is supplied from a second bead reservoir.

In another aspect, the invention features a handliner apparatus, including a carrier cart, means for applying a heated thermoplastic layer onto a surface, disposed on the carrier cart, means for applying a first layer of glass beads onto the heated thermoplastic layer, disposed on the carrier cart, and means for applying a second layer of glass beads onto the combined thermoplastic and first bead layer, disposed on the carrier cart.

One advantage of the present invention is that a first thermoplastic layer can be applied to a surface, followed immediately by a first bead layer, then a second bead layer.

Another advantage of the present invention is that multiple reflective beads can be added to a thermoplastic layer.

Another advantage of the present invention is that multiple reflective beads of differing sizes can be added to a thermoplastic layer.

Other objects, advantages and capabilities of the invention are apparent from the following description taken in conjunction with the accompanying drawings showing the preferred embodiment of the invention.

### BRIEF DESCRIPTION OF THE DRAWINGS

FIG. 1 illustrates a side perspective view of an embodiment of a dual reservoir handliner apparatus;

FIG. 2A illustrates a top view of an interior of an embodiment of a dual reservoir;

FIG. 2B illustrates a side perspective view of an embodiment of a dual hopper;

FIG. 3 illustrates a partial internal side view of an embodiment of a dual reservoir handliner apparatus;

FIG. 4 illustrates a side internal view of an embodiment of a dual hopper;

FIG. 5 illustrates a view of an embodiment of a slotted glass bead roller; and

FIG. 6 illustrates a top plan view of an embodiment of a metering shaft.

### DETAILED DESCRIPTION

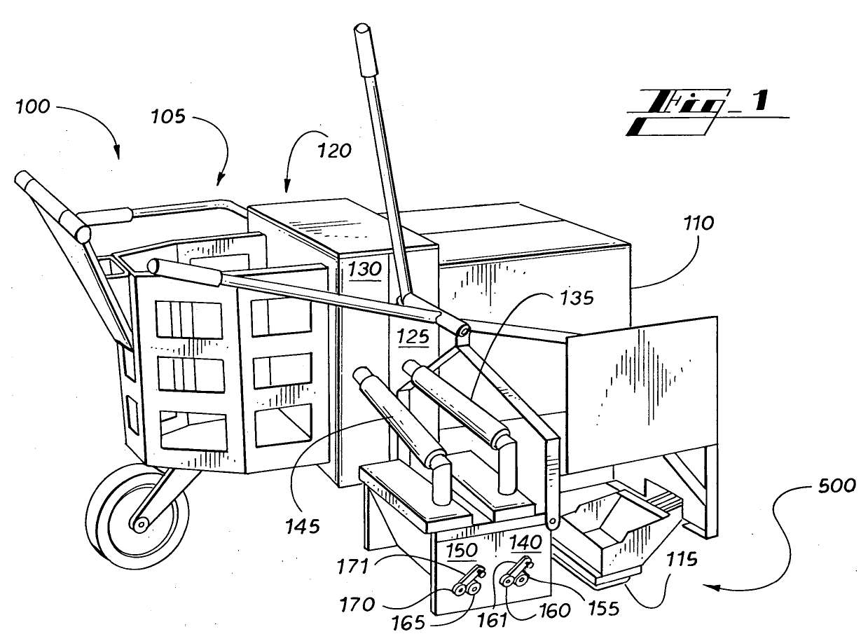

Referring to the drawings wherein like reference numerals designate corresponding parts throughout the several figures, reference is made first to FIG. 1 that illustrates a side perspective view of an embodiment of a dual reservoir handliner apparatus 100. In general, the handliner apparatus 100 includes a carrier cart 105 and a thermoplastic reservoir 110 located in a forward position on the carrier cart 105. The thermoplastic reservoir 110 is coupled to an extruding die 115 for applying heated thermoplastic to a surface 500. In a typical implementation, the heated thermoplastic that is extruded onto the surface 500 contains glass beads.

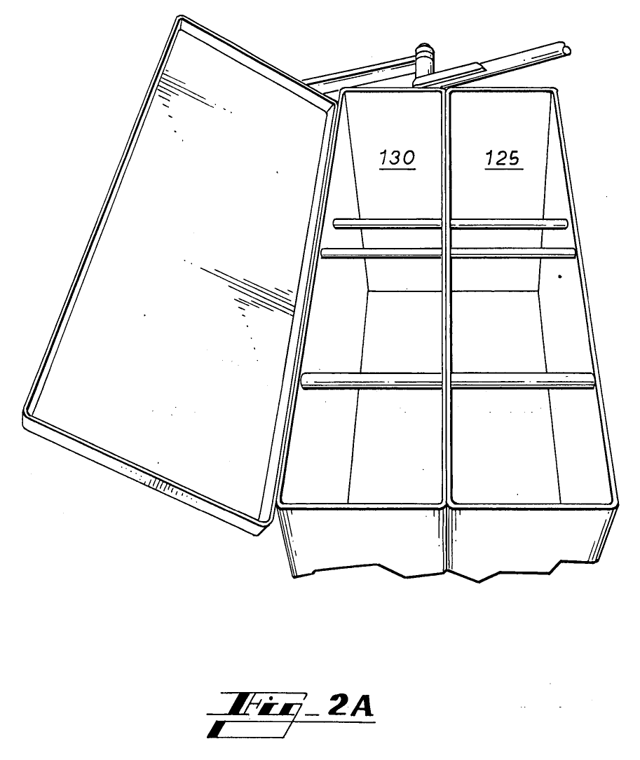

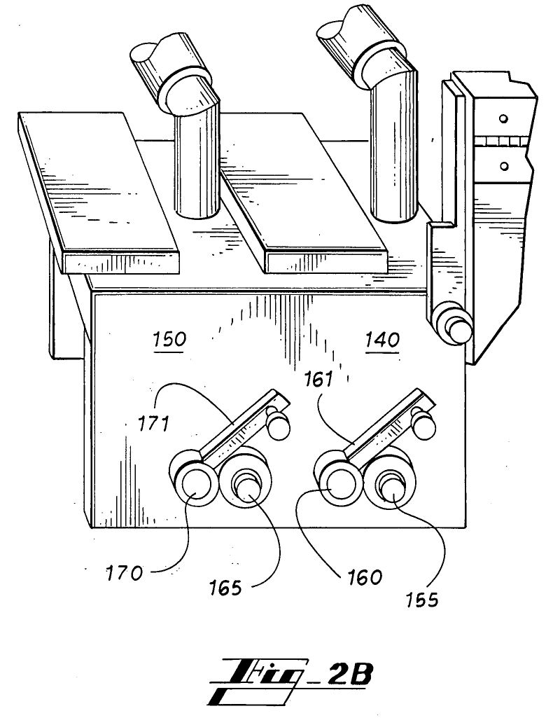

The apparatus 100 further typically includes a dual reservoir 120 located in a position rearward of the thermoplastic reservoir 110. In a typical implementation, the dual reservoir 120 includes beads stored within the reservoir. In a typical embodiment, the dual reservoir 120 comprises a first chamber 125 and a second chamber 130. FIG. 2A illustrates a top view of an interior of an embodiment of a dual reservoir 120 illustrating the hollow interiors of the first and second chambers 125, 130. In general, the first chamber 125 is disposed between the thermoplastic reservoir 110 and the second chamber 130.

The apparatus 100 can further include a first conduit 135 connected between the first chamber 125 and a first hopper 140, and a second conduit 145 connected between the second chamber 130 and a second hopper 150. FIG. 2B illustrates a side perspective view of an embodiment of a dual hopper, having the first hopper 104 and the second hopper 150.

In a typical implementation, the dual reservoir 120 provides a first stream of beads from the first chamber 125 through the first conduit 135 and into the first hopper 140. A first roller 155 and metering shaft 160 control the amount and width of the first stream of beads respectively onto an extruded layer of thermoplastic supplied by the extruding die 115. The dual reservoir 120 further provides a second stream of beads from the second chamber 130 through the second conduit 145 and into the second hopper 150. A second roller 165 and metering shaft 170 controls the amount and width of the first stream of beads respectively onto an extruded layer of thermoplastic supplied by the extruding die 115 and the first layer of beads as described.

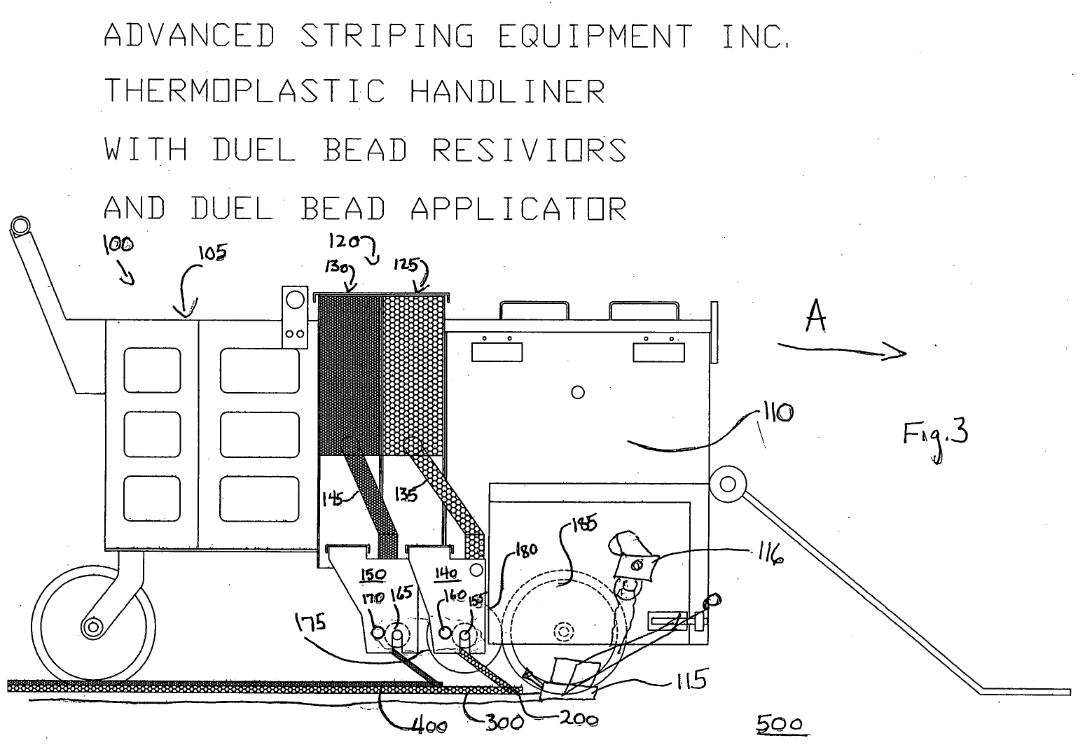

In general, the apparatus 100 can advantageously be implemented to carry out a method of striping on a surface 500. FIG. 3 illustrates a partial internal side view of an embodiment of a dual reservoir handliner apparatus 100. As described above, the apparatus 100 includes a carrier cart 105 and a thermoplastic reservoir 110 located in a forward position on the carrier cart 105. The thermoplastic reservoir 110 is coupled to an extruding die 115 for applying heated thermoplastic to a surface 500. A valve 116 controls the flow of the thermoplastic to the extruder die 115. A dual reservoir 120 is located in a position rearward of the thermoplastic reservoir 110. The dual reservoir 120 typically includes a first chamber 125 and a second chamber 130. In general, the first chamber 125 is disposed between the thermoplastic reservoir 110 and the second chamber 130. The apparatus 100 can further include a first conduit 135 connected between the first chamber 125 and a first hopper 140, and a second conduit 145 connected between the second chamber 130 and a second hopper 150.

In a typical implementation, the dual reservoir 120 provides a first stream of beads from the first chamber 125 through the first conduit 135 and into the first hopper 140. A first roller 155 and metering shaft 160 control the amount and width of the first stream of beads respectively onto an extruded layer of thermoplastic supplied by the extruding die 115. The dual reservoir 120 further provides a second stream of beads from the second chamber 130 through the second conduit 145 and into the second hopper 150. A second roller 165 and metering shaft 170 controls the amount and width of the first stream of beads respectively onto an extruded layer of thermoplastic supplied by the extruding die 115 and the first layer of beads as described. A front wheel 185 of the carrier cart 105 is typically coupled to a coupling wheel 180 connected to the first roller 155. The first roller 155 is then typically coupled to the second roller 165 by a coupling device 175 such as a chain that coupled gears on the first and second rollers 155, 165. Therefore, as the carrier cart 105 is moved forward generally through arrow A, the motion of the wheel 185 coupled circular motion to the wheel 180 and to the rollers 155, 165, thereby allowing glass beads to flow from the hoppers 140, 150.

In the method of striping, a layer of heated thermoplastic 200 is applied to the surface via the extruder die 115. Since the first hopper 140 is adjacent the extruder die 115, the first flow of beads from the chamber 125 occurs at a small interval after the thermoplastic layer 200 is applied. Thus a first glass bead layer 300 is applied to the thermoplastic layer 200. Since the second hopper 150 is adjacent the first hopper 140, the second flow of beads from the chamber 130 occurs at a small internal after the first bead layer 300 is applied. Thus, a second glass bead layer 400 is applied to the combined thermoplastic layer 200 and first glass bead layer 300. In a typical implementation, the first layer of beads 300 comprise beads of a relative size larger than the beads within the second layer of beads. Furthermore, the thermoplastic typically includes glass beads mixed therein. The diameter of the beads can vary greatly; for example, from as little as 30 mils to as large as 90 mils. These stated variations in bead diameter are illustrative of current industry practice and standards, and are not intended to be limiting in view of the present invention and the related method of use, which can accommodate beads of any diameter and material useful for the intended purpose.

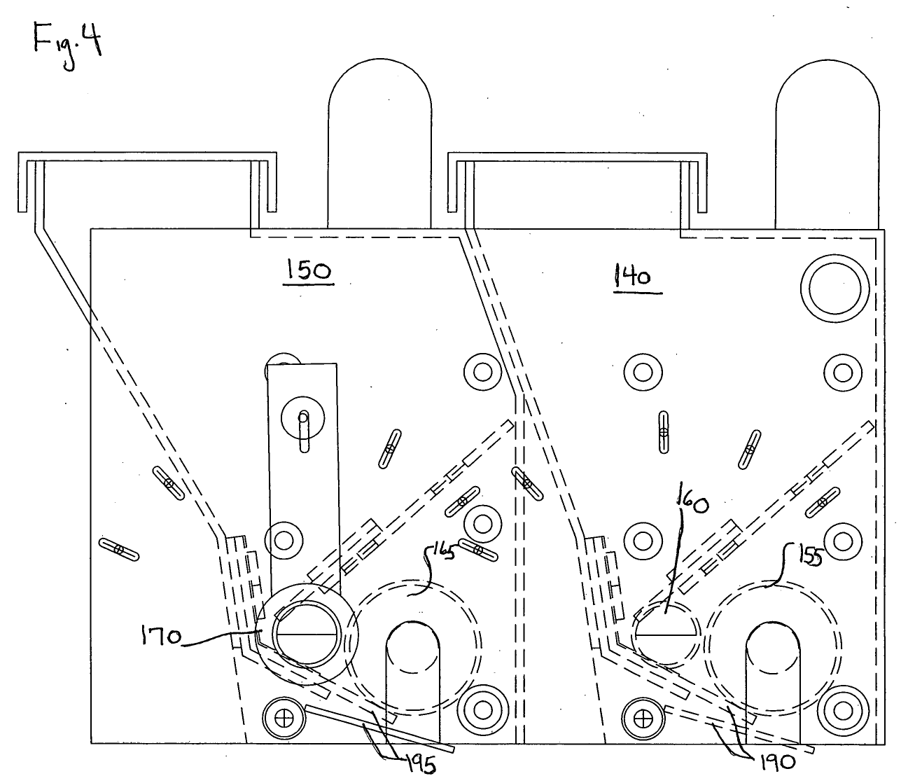

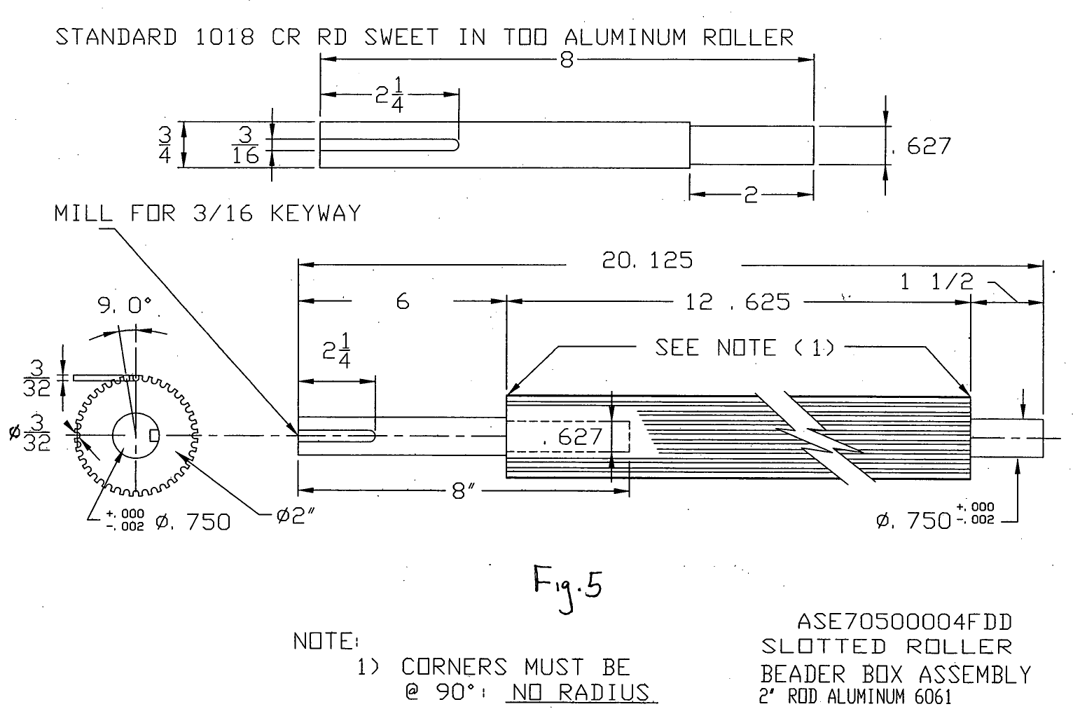

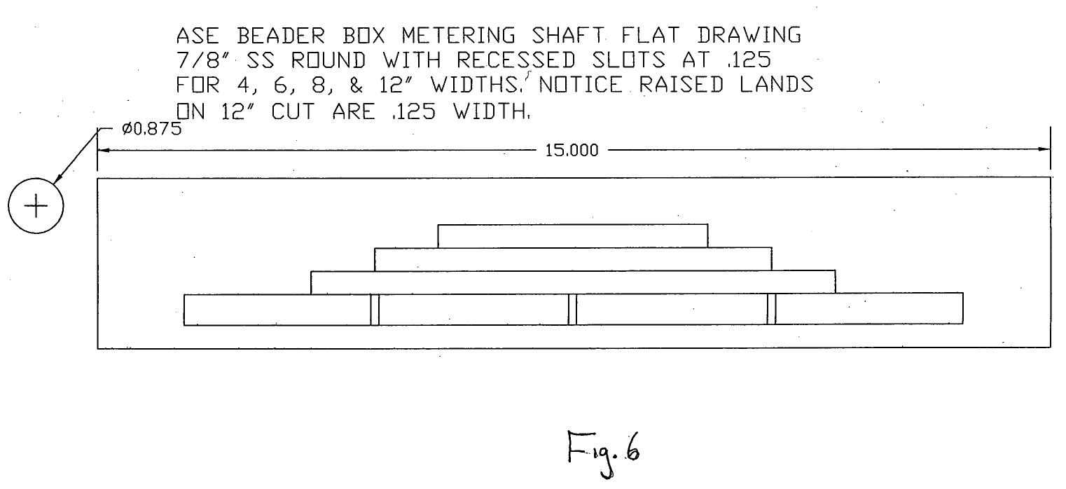

FIG. 4 illustrates a side internal view of an embodiment of a dual hopper having hoppers 140, 150. Each of the hoppers 140, 150 includes the rollers 155, 165 and metering shafts 160, 170. As described above, the rollers 155, 165 typically control the amount of beads that flow from the hoppers 140, 150. Typically, the flow is controlled either by the rollers 155, 165 being slotted or knurled. FIG. 5 illustrates a view of an embodiment of a slotted glass bead roller 155, 165. As further described above, the metering shafts 160, 170 control the width of the applied stripes. By rotating the metering shafts 160, 170, typically via levers 161, 171, the beads flow through recessed slots that increase with size given the rotation of the metering shafts 160, 170. FIG. 6 illustrates a top plan view of an embodiment of a metering shaft 160, 170. The flow of beads can then generally be directed along guide plates 190, 195.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A handliner apparatus, comprising:
a carrier cart;
a thermoplastic reservoir located in a forward position on the carrier cart; and
a dual reservoir located in a position rearward of the thermoplastic reservoir.

2. The apparatus as claimed in claim 1 wherein the dual reservoir includes beads stored within the reservoir.

3. The apparatus as claimed in claim 1 wherein the dual reservoir comprises a first chamber and a second chamber.

4. The apparatus as claimed in claim 3 wherein the first chamber is disposed between the thermoplastic reservoir and the second chamber.

5. The apparatus as claimed in claim 4 further comprising a first hopper connected to the first chamber via a first conduit.

6. The apparatus as claimed in claim 4 further comprising a second hopper connected to the second chamber via a second conduit.

7. The apparatus as claimed in claim 1 wherein the dual reservoir supplies a first stream of glass beads and a second stream of glass beads.

8. The apparatus as claimed in claim 7 wherein the first stream of beads is distributed via a first roller and metering shaft assembly connected to the carrier cart.

9. The apparatus as claimed in claim 7 wherein the second stream of beads is distributed via a second roller and metering shaft assembly connected to the carrier cart.

10. A method of striping, comprising:
applying a layer of heated thermoplastic to a surface;
upon applying the heated layer of thermoplastic, applying a first layer of glass beads to the layer of thermoplastic; and
upon applying the first layer of glass beads to the layer of thermoplastic, applying a second layer of glass beads to the combined layers of thermoplastic and first layer of glass beads.

11. The method as claimed in claim 10, wherein the thermoplastic is extruded from a thermoplastic reservoir.

12. The method as claimed in claim 11 wherein the first layer of beads is supplied from a first bead reservoir.

13. The method as claimed in claim 12 wherein the second layer of beads is supplied from a second bead reservoir.

14. A handliner apparatus, comprising:
a carrier cart;
means for applying a heated thermoplastic layer onto a surface, disposed on the carrier cart;
means for applying a first layer of glass beads onto the heated thermoplastic layer, disposed on the carrier cart; and
means for applying a second layer of glass beads onto the combined thermoplastic and first bead layer, disposed on the carrier cart.
